(19) United States
(12) Patent Application Publication
(10) Pub. No.: US 2023/0291925 A1
(43) Pub. Date: Sep. 14, 2023

(54) Inter-Intra Prediction With Implicit Models

(71) Applicant: Google LLC, Mountain View, CA (US)

(72) Inventors: Debargha Mukherjee, Cupertino, CA (US); Yue Chen, Kirkland, WA (US); Urvang Joshi, Mountain VIew, CA (US); Sarah Parker, San Francisco, CA (US); Elliott Karpilovsky, Santa Clara, CA (US); Hui Su, Sunnyvale, CA (US)

(73) Assignee: Google LLC, Mountain View, CA (US)

(21) Appl. No.: 18/008,209

(22) PCT Filed: Jul. 1, 2020
(86) PCT No.: PCT/US2020/040522

§ 371 Date: Dec. 5, 2022

(51) Int. Cl. H04N 19/52; H04N 19/176; H04N 19/593; H04N 19/105

(52) U.S. Cl. CPC H04N 19/52; H04N 19/176; H04N 19/593; H04N 19/105

(57) ABSTRACT

Video coding in accordance with an inter-intra prediction model may include coding an inter-prediction motion vector for a current block of a current frame, obtaining spatial block-context pixels oriented relative to the current block, generating an inter-prediction block, generating a corresponding set of reference block-context pixels oriented relative to the inter-prediction block, identifying inter-intra prediction parameters that correspond with minimizing error between the spatial block-context pixels and the reference block-context pixels, generating a prediction block for the current block by, for a current pixel of the current block, obtaining an inter-prediction pixel, determining a predictor for the current pixel using a combination of the inter-prediction pixel and the inter-intra prediction parameters, and including the predictor in the prediction block.

### BACKGROUND

Digital images and video can be used, for example, on the internet, for remote business meetings via video conferencing, high definition video entertainment, video advertisements, or sharing of user-generated content. Due to the large amount of data involved in transferring and processing image and video data, high-performance compression may be advantageous for transmission and storage. Accordingly, it would be advantageous to provide high-resolution image and video transmitted over communications channels having limited bandwidth, such as image and video coding using inter-intra prediction with implicit models.

### SUMMARY

This application relates to encoding and decoding of image data, video stream data, or both for transmission or storage. Disclosed herein are aspects of systems, methods, and apparatuses for encoding and decoding using inter-intra prediction with implicit models.

An aspect is a method for video coding using inter-intra prediction with implicit models. Video coding using inter-intra prediction with implicit models may include generating a reconstructed frame corresponding to a current frame from a sequence of video frames. Generating the reconstructed frame may include generating the reconstructed frame in accordance with an inter-intra prediction model. Generating the reconstructed frame in accordance with the inter-intra prediction model may include decoding, from an encoded bitstream, a set of inter-prediction motion vectors for a current block of the current frame, obtaining spatial block-context pixels from the reconstructed frame oriented relative to the current block in accordance with a defined spatial orientation, and generating a set of inter-prediction blocks for the current block using a set of reference frames and the set of inter-prediction motion vectors, wherein generating the set of inter-prediction blocks includes, for a respective inter-prediction block from the set of inter-prediction blocks, generating a corresponding set of reference block-context pixels oriented relative to the respective inter-prediction block in accordance with the defined spatial orientation. Generating the reconstructed frame in accordance with the inter-intra prediction model may include identifying a set of inter-intra prediction parameters that correspond with minimizing error between the spatial block-context pixels and the reference block-context pixels, wherein the set of inter-intra prediction parameters includes a set of blending parameters, wherein the set of blending parameters includes a first blending parameter. Generating the reconstructed frame in accordance with the inter-intra prediction model may include generating a prediction block for the current block by, for a current pixel of the current block, obtaining a set of inter-prediction pixels by, for a respective inter-prediction block from the set of inter-prediction blocks, identifying, from the inter-prediction block, an inter-prediction pixel corresponding to the current pixel, such that the set of inter-prediction pixels includes a first inter-prediction pixel from a first inter-prediction block from the set of inter-prediction blocks, determining a predictor for the current pixel using a combination of the set of inter-prediction pixels and the set of inter-intra prediction parameters, and including the predictor in the prediction block. Generating the reconstructed frame in accordance with the inter-intra prediction model may include decoding a residual block for the current block from the encoded bitstream, wherein decoding the residual block includes decoding a residual pixel corresponding to the current pixel, generating a reconstructed block for the current block by, for the current pixel, identifying, as the current pixel, a sum of the predictor for the current pixel and the residual pixel, and including the reconstructed block in the reconstructed frame. The method may include outputting the reconstructed frame.

Another aspect is a method for video coding using inter-intra prediction with implicit models. Video coding using inter-intra prediction with implicit models may include generating a reconstructed frame corresponding to a current frame from a sequence of video frames. Generating the reconstructed frame may include decoding, from an encoded bitstream, an inter-prediction motion vector for a current block of the current frame, obtaining spatial block-context pixels from the reconstructed frame oriented relative to the current block in accordance with a defined spatial orientation, generating an inter-prediction block for the current block using a reference frame and the inter-prediction motion vector, wherein generating the inter-prediction block includes generating reference block-context pixels oriented relative to the inter-prediction block in accordance with the defined spatial orientation, obtaining an inter-intra prediction parameter that corresponds with minimizing error between the spatial block-context pixels and the reference block-context pixels, and generating a prediction block for the current block by, for a current pixel of the current block, determining a predictor for the current pixel using a combination of an inter-prediction pixel from the inter-prediction block corresponding to the current pixel and the inter-intra prediction parameter, and including the predictor in the prediction block. Generating the reconstructed frame may include decoding a residual block for the current block from the encoded bitstream, wherein decoding the residual block includes decoding a residual pixel corresponding to the current pixel, generating a reconstructed block for the current block by, for the current pixel, identifying a sum of the predictor for the current pixel and the residual pixel as the current pixel, and including the reconstructed block in the reconstructed frame. The method may include outputting the reconstructed frame.

Another aspect is a method for video coding using inter-intra prediction with implicit models. Video coding using inter-intra prediction with implicit models may include generating an encoded frame by encoding a current frame from a sequence of input video frames. Encoding the current frame may include generating a portion of a reconstructed frame corresponding to the current frame, identifying a current block of the current frame, generating a first inter-prediction block for the current block using a first reference frame. Generating the first inter-prediction block may include identifying a first inter-prediction motion vector and generating first reference block-context pixels oriented relative to the first inter-prediction block in accordance with a defined spatial orientation. Encoding the current frame may include obtaining spatial block-context pixels from the reconstructed frame oriented relative to the current block in accordance with the defined spatial orientation, obtaining a first inter-intra prediction parameter that corresponds with minimizing error between the spatial block-context pixels and the first reference block-context pixels, and generating a prediction block for the current block by, for a current pixel of the current block, determining a predictor for the current pixel using a combination of an inter-prediction pixel from the first inter-prediction block corresponding to the current pixel and the first inter-intra prediction parameter, and including the predictor in the prediction block. Encoding the current frame may include generating a residual block for the current block, wherein generating the residual block includes generating, as a residual pixel corresponding to the current pixel, a difference between the predictor and the current pixel, and including, in an output bitstream, the residual block and the first inter-prediction motion vector. The method may include outputting the output bitstream.

Another aspect is an apparatus for video coding using inter-intra prediction with implicit models. The apparatus may include a processor configured to generate a reconstructed frame corresponding to a current frame from a sequence of video frames. The processor may be configured to generate the reconstructed frame in accordance with the inter-intra prediction model may by decoding, from an encoded bitstream, a set of inter-prediction motion vectors for a current block of the current frame, obtaining spatial block-context pixels from the reconstructed frame oriented relative to the current block in accordance with a defined spatial orientation, and generating a set of inter-prediction blocks for the current block using a set of reference frames and the set of inter-prediction motion vectors, wherein generating the set of inter-prediction blocks includes, for a respective inter-prediction block from the set of inter-prediction blocks, generating a corresponding set of reference block-context pixels oriented relative to the respective inter-prediction block in accordance with the defined spatial orientation. The processor may be configured to generate the reconstructed frame in accordance with the inter-intra prediction model by identifying a set of inter-intra prediction parameters that correspond with minimizing error between the spatial block-context pixels and the reference block-context pixels, wherein the set of inter-intra prediction parameters includes a set of blending parameters, wherein the set of blending parameters includes a first blending parameter. The processor may be configured to generate the reconstructed frame in accordance with the inter-intra prediction model by generating a prediction block for the current block by, for a current pixel of the current block, obtaining a set of inter-prediction pixels by, for a respective inter-prediction block from the set of inter-prediction blocks, identifying, from the inter-prediction block, an inter-prediction pixel corresponding to the current pixel, such that the set of inter-prediction pixels includes a first inter-prediction pixel from a first inter-prediction block from the set of inter-prediction blocks, determining a predictor for the current pixel using a combination of the set of inter-prediction pixels and the set of inter-intra prediction parameters, and including the predictor in the prediction block. The processor may be configured to generate the reconstructed frame in accordance with the inter-intra prediction model by decoding a residual block for the current block from the encoded bitstream, wherein decoding the residual block includes decoding a residual pixel corresponding to the current pixel, generating a reconstructed block for the current block by, for the current pixel, identifying, as the current pixel, a sum of the predictor for the current pixel and the residual pixel, and including the reconstructed block in the reconstructed frame. The processor may be configured to generate output the reconstructed frame.

Another aspect is an apparatus for video coding using inter-intra prediction with implicit models. The apparatus may include a processor configured to generate a reconstructed frame corresponding to a current frame from a sequence of video frames. The processor may be configured to generate the reconstructed frame by decoding, from an encoded bitstream, an inter-prediction motion vector for a current block of the current frame, obtaining spatial block-context pixels from the reconstructed frame oriented relative to the current block in accordance with a defined spatial orientation, generating an inter-prediction block for the current block using a reference frame and the inter-prediction motion vector, wherein generating the inter-prediction block includes generating reference block-context pixels oriented relative to the inter-prediction block in accordance with the defined spatial orientation, obtaining an inter-intra prediction parameter that corresponds with minimizing error between the spatial block-context pixels and the reference block-context pixels, and generating a prediction block for the current block by, for a current pixel of the current block, determining a predictor for the current pixel using a combination of an inter-prediction pixel from the inter-prediction block corresponding to the current pixel and the inter-intra prediction parameter, and including the predictor in the prediction block. The processor may be configured to generate the reconstructed frame by decoding a residual block for the current block from the encoded bitstream, wherein decoding the residual block includes decoding a residual pixel corresponding to the current pixel, generating a reconstructed block for the current block by, for the current pixel, identifying a sum of the predictor for the current pixel and the residual pixel as the current pixel, and including the reconstructed block in the reconstructed frame. The processor may be configured to generate output the reconstructed frame.

Another aspect is an apparatus for video coding using inter-intra prediction with implicit models. The apparatus may include a processor configured to generate an encoded frame by encoding a current frame from a sequence of input video frames. The processor may be configured to encode the current frame by generating a portion of a reconstructed frame corresponding to the current frame, identifying a current block of the current frame, generating a first inter-prediction block for the current block using a first reference frame. The processor may be configured to generate the first inter-prediction block by identifying a first inter-prediction motion vector and generating first reference block-context pixels oriented relative to the first inter-prediction block in accordance with a defined spatial orientation. The processor may be configured to encode the current frame by obtaining spatial block-context pixels from the reconstructed frame oriented relative to the current block in accordance with the defined spatial orientation, obtaining a first inter-intra prediction parameter that corresponds with minimizing error between the spatial block-context pixels and the first reference block-context pixels, and generating a prediction block for the current block by, for a current pixel of the current block, determining a predictor for the current pixel using a combination of an inter-prediction pixel from the first inter-prediction block corresponding to the current pixel and the first inter-intra prediction parameter, and including the predictor in the prediction block. The processor may be configured to encode the current frame by generating a residual block for the current block, wherein generating the residual block includes generating, as a residual pixel corresponding to the current pixel, a difference between the predictor and the current pixel, and including, in an output bitstream, the residual block and the first inter-prediction motion vector. The processor may be configured to output the output bitstream.

In some implementations, coding using inter-intra prediction with implicit models may include identifying the inter-intra prediction model by decoding, from the encoded bitstream, an inter-intra prediction model identifier that identifies the inter-intra prediction model.

In some implementations, coding using inter-intra prediction with implicit models may include decoding the set of inter-prediction motion vectors by decoding a first inter-prediction motion vector of the set of inter-prediction motion vectors, wherein first inter-prediction motion vector is associated with a first reference frame of the set of reference frames.

In some implementations, coding using inter-intra prediction with implicit models may include generating the set of inter-prediction blocks by generating the first inter-prediction block using the first inter-prediction motion vector and the first reference frame, wherein generating the first inter-prediction block includes generating a first set of reference block-context pixels oriented relative to the first inter-prediction block.

In some implementations, coding using inter-intra prediction with implicit models may include determining the predictor by identifying a first value as a product of multiplying the first inter-prediction pixel by the first blending parameter, and identifying, as the predictor, a sum of a set of values, wherein the set of values includes the first value.

In some implementations, coding using inter-intra prediction with implicit models may include identifying the set of inter-intra prediction parameters such that the set of inter-intra prediction parameters correspond with minimizing error between the spatial block-context pixels and the first set of reference block-context pixels.

In some implementations, coding using inter-intra prediction with implicit models may include decoding the set of inter-prediction motion vectors by decoding a second inter-prediction motion vector of the set of inter-prediction motion vectors, wherein the set of reference frames includes a second reference frame.

In some implementations, coding using inter-intra prediction with implicit models may include generating the set of inter-prediction blocks by generating a second inter-prediction block of the set of inter-prediction blocks using the second inter-prediction motion vector and the second reference frame, wherein generating the second inter-prediction block includes generating a second set of reference block-context pixels oriented relative to the second inter-prediction block.

In some implementations, coding using inter-intra prediction with implicit models may include obtaining the set of inter-prediction pixels by identifying, from the second inter-prediction block, a second inter-prediction pixel corresponding to the current pixel, such that the set of inter-prediction pixels includes the second inter-prediction pixel.

In some implementations, coding using inter-intra prediction with implicit models may include identifying the set of inter-intra prediction parameters by identifying the set of inter-intra prediction parameters such that the set of inter-intra prediction parameters correspond with minimizing error between the spatial block-context pixels, the first set of reference block-context pixels, and the second set of reference block-context pixels.

In some implementations, coding using inter-intra prediction with implicit models may include determining the predictor by identifying a second value as a product of multiplying the second inter-prediction pixel by a difference of subtracting the first blending parameter from one, and including the second value in the set of values.

In some implementations, coding using inter-intra prediction with implicit models may include identifying the set of inter-intra prediction parameters by identifying the set of blending parameters such that the blending parameters includes a second blending parameter.

In some implementations, coding using inter-intra prediction with implicit models may include determining the predictor by identifying a second value as a product of multiplying the second inter-prediction pixel by the second blending parameter and including the second value in the set of values.

In some implementations, coding using inter-intra prediction with implicit models may include identifying the set of inter-intra prediction parameters includes identifying a set of recursive factors.

In some implementations, coding using inter-intra prediction with implicit models may include determining the predictor by identifying a set of available pixel-context pixels from the reconstructed frame having a defined spatial orientation relative to the current pixel, identifying a dot product of the set of available pixel-context pixels and the set of recursive factors, and including the dot product in the set of values.

In some implementations, coding using inter-intra prediction with implicit models may include decoding the set of inter-prediction motion vectors by decoding a second inter-prediction motion vector of the set of inter-prediction motion vectors, wherein the set of reference frames includes a second reference frame.

In some implementations, coding using inter-intra prediction with implicit models may include generating the set of inter-prediction blocks by generating a second inter-prediction block of the set of inter-prediction blocks using the second inter-prediction motion vector and the second reference frame, wherein generating the second inter-prediction block includes generating a second set of reference block-context pixels oriented relative to the second inter-prediction block.

In some implementations, coding using inter-intra prediction with implicit models may include obtaining the set of inter-prediction pixels by identifying, from the second inter-prediction block, a second inter-prediction pixel corresponding to the current pixel, such that the set of inter-prediction pixels includes the second inter-prediction pixel.

In some implementations, coding using inter-intra prediction with implicit models may include identifying the set of inter-intra prediction parameters by identifying the set of inter-intra prediction parameters such that the set of inter-intra prediction parameters correspond with minimizing error between the spatial block-context pixels, the first set of reference block-context pixels, and the second set of reference block-context pixels.

In some implementations, coding using inter-intra prediction with implicit models may include determining the predictor by identifying a second value as a product of multiplying the second inter-prediction pixel by a difference of subtracting the first blending parameter from one, and including the second value in the set of values.

In some implementations, coding using inter-intra prediction with implicit models may include identifying the set of inter-intra prediction parameters by identifying the set of blending parameters such that the blending parameters includes a second blending parameter.

In some implementations, coding using inter-intra prediction with implicit models may include determining the predictor by identifying a second value as a product of multiplying the second inter-prediction pixel by the second blending parameter and including the second value in the set of values.

In some implementations, coding using inter-intra prediction with implicit models may include identifying the set of inter-intra prediction parameters by identifying an offset, and determining the predictor includes including the offset in the set of values.

Variations in these and other aspects will be described in additional detail hereafter.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a block diagram of a representation of a portion of a frame in accordance with implementations of this disclosure.

FIG. 7 is a flowchart diagram of an example of decoding using inter-intra prediction with implicit models in accordance with implementations of this disclosure.

FIG. 8 is a flowchart diagram of an example of generating a prediction block for coding using inter-intra prediction with implicit models in accordance with implementations of this disclosure.

FIG. 9 is a block diagram of an example of image elements for coding using inter-ultra prediction with implicit models in accordance with implementations of this disclosure.

FIG. 10 is a flowchart diagram of an example of encoding using inter-intra prediction with implicit models in accordance with implementations of this disclosure.

### DETAILED DESCRIPTION

Image and video compression schemes may include breaking an image, or frame, into smaller portions, such as blocks, and generating an output bitstream using techniques to minimize the bandwidth utilization of the information included for each block in the output. In some implementations, the information included for each block in the output may be limited by reducing spatial redundancy, reducing temporal redundancy, or a combination thereof. For example, temporal or spatial redundancies may be reduced by predicting a frame, or a portion thereof, based on information available to both the encoder and decoder, and including information representing a difference, or residual, between the predicted frame and the original frame in the encoded bitstream. The residual information may be further compressed by transforming the residual information into transform coefficients, quantizing the transform coefficients, and entropy coding the quantized transform coefficients. Other coding information, such as motion information, may be included in the encoded bitstream, which may include transmitting differential information based on predictions of the encoding information, which may be entropy coded to further reduce the corresponding bandwidth utilization. An encoded bitstream can be decoded to reconstruct the blocks and the source images from the limited information. In some implementations, the accuracy, efficiency, or both, of coding a block using either inter-prediction or intra-prediction may be limited.

Implementations of coding, such as encoding or decoding, using inter-intra prediction with implicit models may improve the accuracy, efficiency, or both of video coding relative to coding using either inter-prediction or intra-prediction. Coding using inter-intra prediction with implicit models may include coding a current block by generating a corresponding predicted block by generating an corresponding inter-prediction block, which may include generating reference block-context pixels spatially oriented relative to the inter-prediction block in accordance with a defined orientation, obtaining spatial block-context pixels, which may be previously reconstructed pixels from the current frame, obtaining inter-intra prediction parameters by solving an error minimization with respect to the reference block-context pixels and the spatial block-context pixels, and generating predictors for the current block based on the inter-predicted block and the inter-intra prediction parameters.

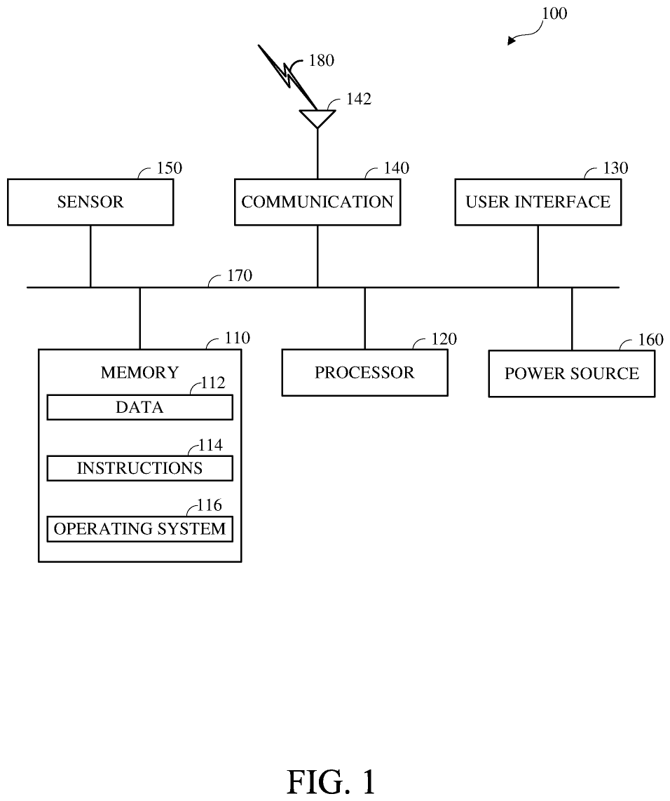

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid state drive, a memory card, removable media, a read-only memory (ROM), a random-access memory (RAM), any type of disk including a hard disk, a floppy disk, an optical disk, a magnetic or optical card, an application-specific integrated circuits (ASICs), or any type of non-transitory media suitable for storing electronic information, or any combination thereof.

Although shown a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input audio data, encoded audio data, decoded audio data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, that may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, 100 the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

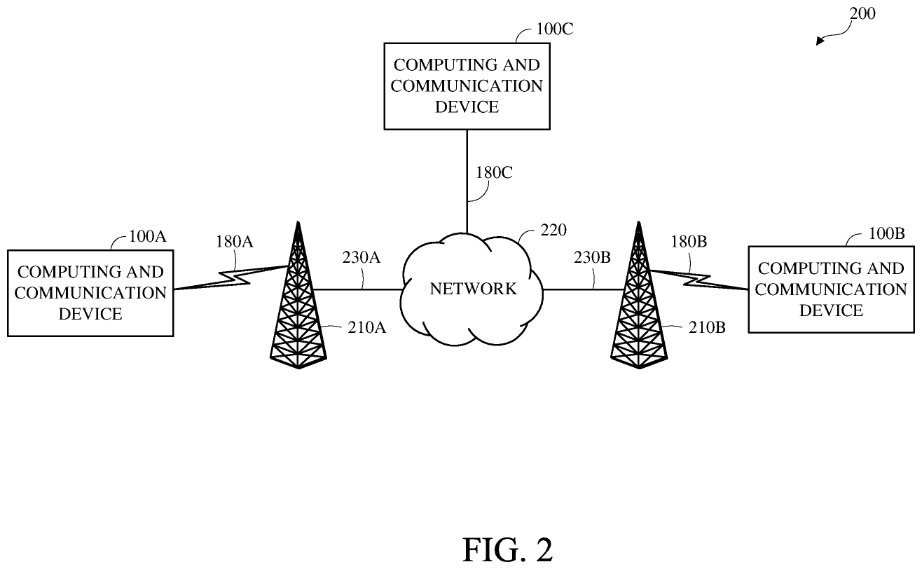

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some or all of the functions of a user device, or some or all of the functions of a server and a user device. For example, the server computing and communication device 100C may receive, encode, process, store, transmit, or a combination thereof audio data and one or both of the computing and communication device 100A and the computing and communication device 100B may receive, decode, process, store, present, or a combination thereof the audio data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VoIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP) the HyperText Transport Protocol (HTTP), or a combination thereof.

The computing and communication devices 100A, 100B, 100C can communicate with each other via the network 220 using one or more a wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communicating devices, networks, and access points.

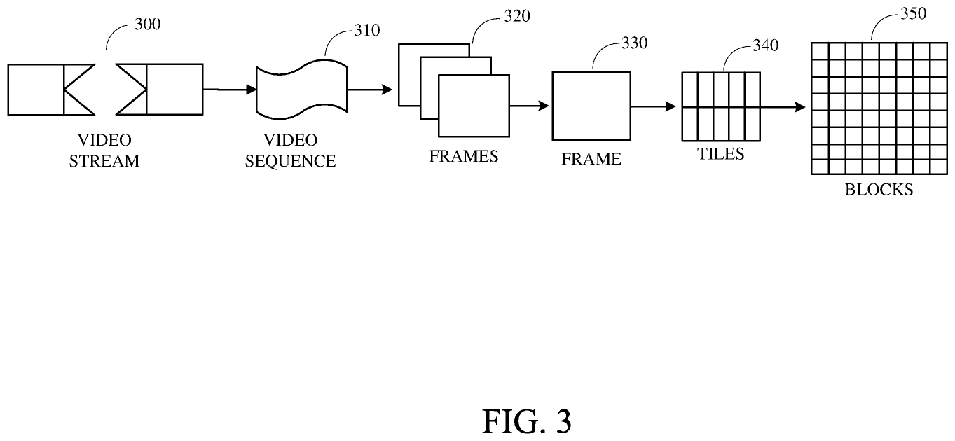

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

Each frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. Each of the tiles 340 may be a rectangular region of the frame that can be coded independently. Each of the tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

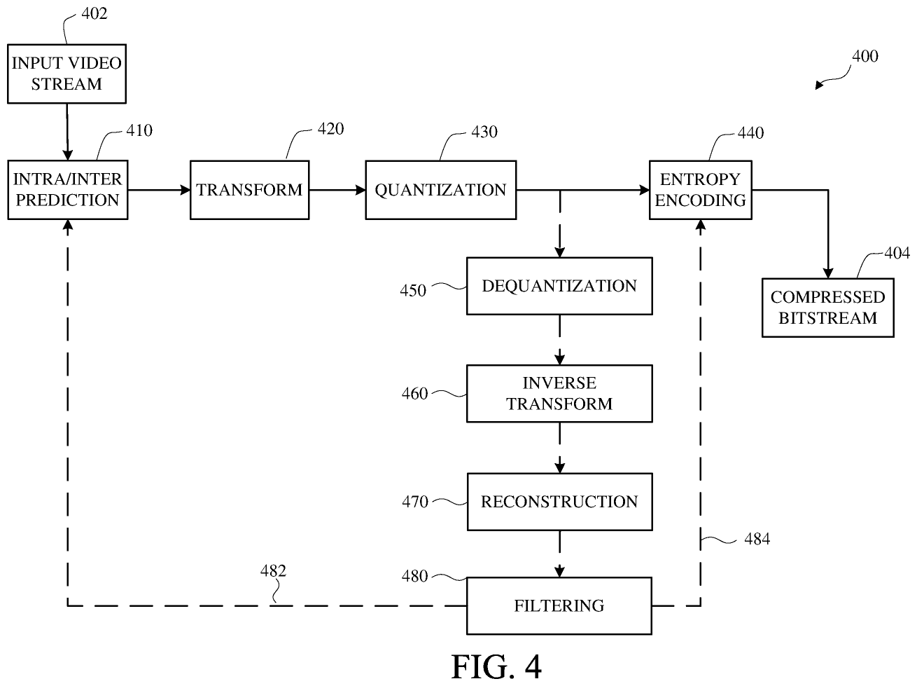

FIG. 4 is a block diagram of an encoder 400 in accordance with implementations of this disclosure. Encoder 400 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3, to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference portion of the reference frame.

The intra/inter prediction unit 410 may subtract the prediction block from the current block (raw block) to produce a residual block. The transform unit 420 may perform a block-based transform, which may include transforming the residual block into transform coefficients in, for example, the frequency domain. Examples of block-based transforms include the Karhunen-Loève Transform (KLT), the Discrete Cosine Transform (DCT), the Singular Value Decomposition Transform (SVD), and the Asymmetric Discrete Sine Transform (ADST). In an example, the DCT may include transforming a block into the frequency domain. The DCT may include using transform coefficient values based on spatial frequency, with the lowest frequency (i.e. DC) coefficient at the top-left of the matrix and the highest frequency coefficient at the bottom-right of the matrix.

The quantization unit 430 may convert the transform coefficients into discrete quantum values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the block, which may include the type of prediction used, motion vectors, and quantizer values, can be output to the compressed bitstream 404. The compressed bitstream 404 can be formatted using various techniques, such as run-length encoding (RLE) and zero-run coding.

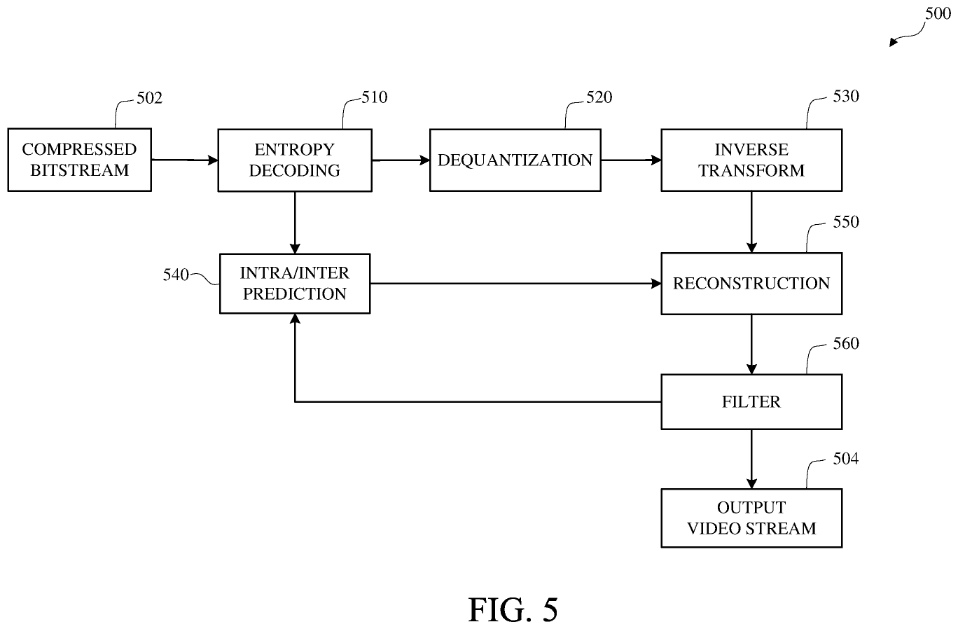

The reconstruction path can be used to maintain reference frame synchronization between the encoder 400 and a corresponding decoder, such as the decoder 500 shown in FIG. 5. The reconstruction path may be similar to the decoding process discussed below and may include decoding the encoded frame, or a portion thereof, which may include decoding an encoded block, which may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a decoded block. The filtering unit 480 can be applied to the decoded block to generate a reconstructed block, which may reduce distortion, such as blocking artifacts. Although one filtering unit 480 is shown in FIG. 4, filtering the decoded block may include loop filtering, deblocking filtering, or other types of filtering or combinations of types of filtering. The reconstructed block may be stored or otherwise made accessible as a reconstructed block, which may be a portion of a reference frame, for encoding another portion of the current frame, another frame, or both, as indicated by the broken line at 482. Coding information, such as deblocking threshold index values, for the frame may be encoded, included in the compressed bitstream 404, or both, as indicated by the broken line at 484.

Other variations of the encoder 400 can be used to encode the compressed bitstream 404. For example, a non-transform-based encoder 400 can quantize the residual block directly without the transform unit 420. In some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a filtering unit 560, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond to the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a decoded block. The filtering unit 560 can be applied to the decoded block to reduce artifacts, such as blocking artifacts, which may include loop filtering, deblocking filtering, or other types of filtering or combinations of types of filtering, and which may include generating a reconstructed block, which may be output as the output video stream 504.

Other variations of the decoder 500 can be used to decode the compressed bitstream 502. For example, the decoder 500 can produce the output video stream 504 without the deblocking filtering unit 570.

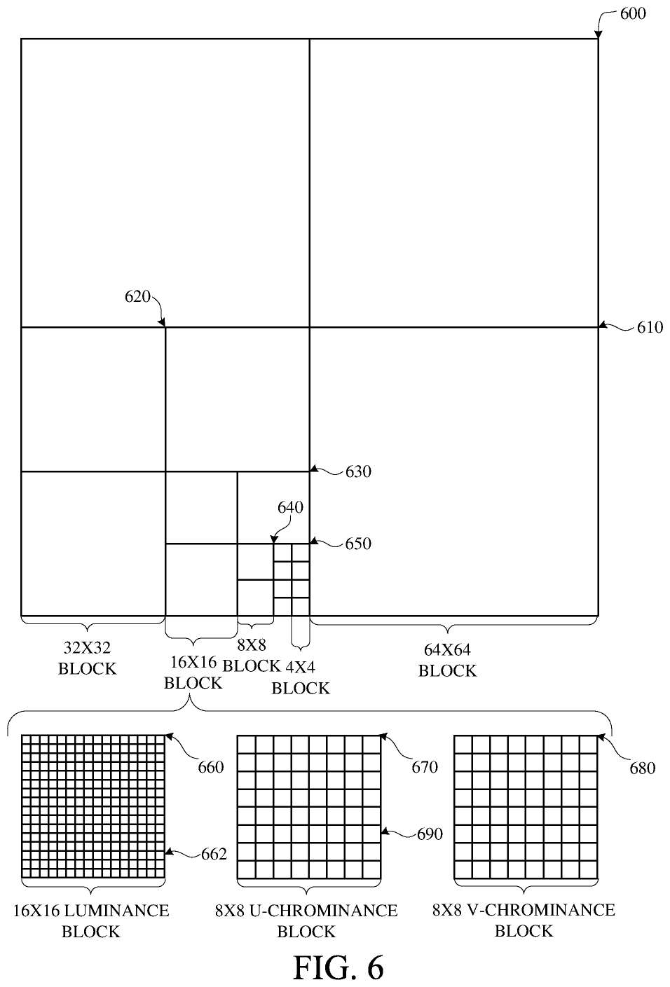

FIG. 6 is a block diagram of a representation of a portion 600 of a frame, such as the frame 330 shown in FIG. 3, in accordance with implementations of this disclosure. As shown, the portion 600 of the frame includes four 64×64 blocks 610, in two rows and two columns in a matrix or Cartesian plane. In some implementations, a 64×64 block may be a maximum coding unit, N=64. Each 64×64 block may include four 32×32 blocks 620. Each 32×32 block may include four 16×16 blocks 630. Each 16×16 block may include four 8×8 blocks 640. Each 8×8 block 640 may include four 4×4 blocks 650. Each 4×4 block 650 may include 16 pixels, which may be represented in four rows and four columns in each respective block in the Cartesian plane or matrix. The pixels may include information representing an image captured in the frame, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used. For example, 32×64 blocks, 64×32 blocks, 16×32 blocks, 32×16 blocks, or any other size blocks may be used. In some implementations, N×2N blocks, 2N×N blocks, or a combination thereof may be used.

In some implementations, video coding may include ordered block-level coding. Ordered block-level coding may include coding blocks of a frame in an order, such as raster-scan order, wherein blocks may be identified and processed starting with a block in the upper left corner of the frame, or portion of the frame, and proceeding along rows from left to right and from the top row to the bottom row, identifying each block in turn for processing. For example, the 64×64 block in the top row and left column of a frame may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block may include using quad-tree coding, which may include coding smaller block units within a block in raster-scan order. For example, the 64×64 block shown in the bottom left corner of the portion of the frame shown in FIG. 6, may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, video coding may include compressing the information included in an original, or input, frame by, for example, omitting some of the information in the original frame from a corresponding encoded frame. For example, coding may include reducing spectral redundancy, reducing spatial redundancy, reducing temporal redundancy, or a combination thereof.

In some implementations, reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of a frame and using a relatively small amount of information to represent each corresponding chrominance component for the portion of the frame. For example, a portion of a frame may be represented by a high-resolution luminance component, which may include a 16×16 block of pixels, and by two lower resolution chrominance components, each of which represents the portion of the frame as an 8×8 block of pixels. A pixel may indicate a value, for example, a value in the range from 0 to 255, and may be stored or transmitted using, for example, eight bits. Although this disclosure is described in reference to the YUV color model, any color model may be used.

In some implementations, reducing spatial redundancy may include transforming a block into the frequency domain using, for example, a discrete cosine transform (DCT). For example, a unit of an encoder, such as the transform unit 420 shown in FIG. 4, may perform a DCT using transform coefficient values based on spatial frequency.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different spatial location and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a portion of a reference frame that corresponds to a current block or pixel of a current frame. For example, a reference frame, or a portion of a reference frame, which may be stored in memory, may be searched to identify a portion for generating a prediction to use for encoding a current block or pixel of the current frame with maximal efficiency. For example, the search may identify a portion of the reference frame for which the difference in pixel values between the current block and a prediction block generated based on the portion of the reference frame is minimized and may be referred to as motion searching. In some implementations, the portion of the reference frame searched may be limited. For example, the portion of the reference frame searched, which may be referred to as the search area, may include a limited number of rows of the reference frame. In an example, identifying the portion of the reference frame for generating a prediction may include calculating a cost function, such as a sum of absolute differences (SAD), between the pixels of portions of the search area and the pixels of the current block.

In some implementations, the spatial difference between the location of the portion of the reference frame for generating a prediction in the reference frame and the current block in the current frame may be represented as a motion vector. The difference in pixel values between the prediction block and the current block may be referred to as differential data, residual data, a prediction error, or as a residual block. In some implementations, generating motion vectors may be referred to as motion estimation, and a pixel of a current block may be indicated based on location using Cartesian coordinates as f_{x,y}. Similarly, a pixel of the search area of the reference frame may be indicated based on location using Cartesian coordinates as r_{x,y}. A motion vector (MV) for the current block may be determined based on, for example, a SAD between the pixels of the current frame and the corresponding pixels of the reference frame.

Although described herein with reference to matrix or Cartesian representation of a frame for clarity, a frame may be stored, transmitted, processed, or any combination thereof, in any data structure such that pixel values may be efficiently represented for a frame or image. For example, a frame may be stored, transmitted, processed, or any combination thereof, in a two-dimensional data structure such as a matrix as shown, or in a one-dimensional data structure, such as a vector array. In an implementation, a representation of the frame, such as a two-dimensional representation as shown, may correspond to a physical location in a rendering of the frame as an image. For example, a location in the top left corner of a block in the top left corner of the frame may correspond with a physical location in the top left corner of a rendering of the frame as an image.

In some implementations, block-based coding efficiency may be improved by partitioning input blocks into one or more prediction partitions, which may be rectangular, including square, partitions for prediction coding. In some implementations, video coding using prediction partitioning may include selecting a prediction partitioning scheme from among multiple candidate prediction partitioning schemes. For example, in some implementations, candidate prediction partitioning schemes for a 64×64 coding unit may include rectangular size prediction partitions ranging in sizes from 4×4 to 64×64, such as 4×4, 4×8, 8×4, 8×8, 8×16, 16×8, 16×16, 16×32, 32×16, 32×32, 32×64, 64×32, or 64×64. In some implementations, video coding using prediction partitioning may include a full prediction partition search, which may include selecting a prediction partitioning scheme by encoding the coding unit using each available candidate prediction partitioning scheme and selecting the best scheme, such as the scheme that produces the least rate-distortion error.

In some implementations, encoding a video frame may include identifying a prediction partitioning scheme for encoding a current block, such as block 610. In some implementations, identifying a prediction partitioning scheme may include determining whether to encode the block as a single prediction partition of maximum coding unit size, which may be 64×64 as shown, or to partition the block into multiple prediction partitions, which may correspond with the sub-blocks, such as the 32×32 blocks 620 the 16×16 blocks 630, or the 8×8 blocks 640, as shown, and may include determining whether to partition into one or more smaller prediction partitions. For example, a 64×64 block may be partitioned into four 32×32 prediction partitions. Three of the four 32×32 prediction partitions may be encoded as 32×32 prediction partitions and the fourth 32×32 prediction partition may be further partitioned into four 16×16 prediction partitions. Three of the four 16×16 prediction partitions may be encoded as 16×16 prediction partitions and the fourth 16×16 prediction partition may be further partitioned into four 8×8 prediction partitions, each of which may be encoded as an 8×8 prediction partition. In some implementations, identifying the prediction partitioning scheme may include using a prediction partitioning decision tree.

In some implementations, video coding for a current block may include identifying an optimal prediction coding mode from multiple candidate prediction coding modes, which may provide flexibility in handling video signals with various statistical properties and may improve the compression efficiency. For example, a video coder may evaluate each candidate prediction coding mode to identify the optimal prediction coding mode, which may be, for example, the prediction coding mode that minimizes an error metric, such as a rate-distortion cost, for the current block. In some implementations, the complexity of searching the candidate prediction coding modes may be reduced by limiting the set of available candidate prediction coding modes based on similarities between the current block and a corresponding prediction block. In some implementations, the complexity of searching each candidate prediction coding mode may be reduced by performing a directed refinement mode search. For example, metrics may be generated for a limited set of candidate block sizes, such as 16×16, 8×8, and 4×4, the error metric associated with each block size may be in descending order, and additional candidate block sizes, such as 4×8 and 8×4 block sizes, may be evaluated.

In some implementations, block-based coding efficiency may be improved by partitioning a current residual block into one or more transform partitions, which may be rectangular, including square, partitions for transform coding. In some implementations, video coding using transform partitioning may include selecting a uniform transform partitioning scheme. For example, a current residual block, such as block 610, may be a 64×64 block and may be transformed without partitioning using a 64×64 transform.

Although not expressly shown in FIG. 6, a residual block may be transform partitioned using a uniform transform partitioning scheme. For example, a 64×64 residual block may be transform partitioned using a uniform transform partitioning scheme including four 32×32 transform blocks, using a uniform transform partitioning scheme including sixteen 16×16 transform blocks, using a uniform transform partitioning scheme including sixty-four 8×8 transform blocks, or using a uniform transform partitioning scheme including 256 4×4 transform blocks.

In some implementations, video coding using transform partitioning may include identifying multiple transform block sizes for a residual block using multiform transform partition coding. In some implementations, multiform transform partition coding may include recursively determining whether to transform a current block using a current block size transform or by partitioning the current block and multiform transform partition coding each partition. For example, the bottom left block 610 shown in FIG. 6 may be a 64×64 residual block, and multiform transform partition coding may include determining whether to code the current 64×64 residual block using a 64×64 transform or to code the 64×64 residual block by partitioning the 64×64 residual block into partitions, such as four 32×32 blocks 620, and multiform transform partition coding each partition. In some implementations, determining whether to transform partition the current block may be based on comparing a cost for encoding the current block using a current block size transform to a sum of costs for encoding each partition using partition size transforms.

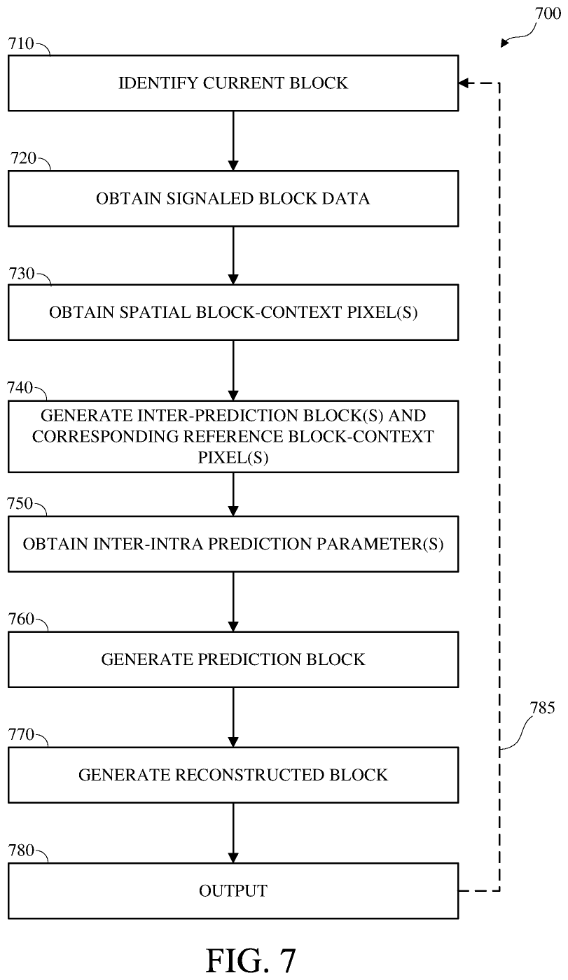

FIG. 7 is a flowchart diagram of an example of decoding using inter-intra prediction with implicit models 700 in accordance with implementations of this disclosure. Decoding using inter-intra prediction with implicit models 700 may be implemented in a decoder, such as the decoder 500 shown in FIG. 5.

As shown in FIG. 7, decoding using inter-intra prediction with implicit models 700 includes identifying a current block at 710, obtaining signaled block data at 720, obtaining one or more spatial block-context pixels at 730, generating one or more inter-prediction blocks at 740, obtaining one or more inter-intra prediction parameters at 750, generating a prediction block at 760, generating a reconstructed block at 770, and outputting at 780.

Although not expressly shown in FIG. 7, decoding using inter-intra prediction with implicit models 700 may include obtaining, such as receiving via a wired or wireless electronic communication medium, such as the network 220 shown in FIG. 2, or reading from an electronic data storage medium, such as the memory 110 shown in FIG. 1, at least a portion of an encoded bitstream. Although not expressly shown in FIG. 7, decoding using inter-intra prediction with implicit models 700 may include decoding one or more frame parameters for decoding the current frame, generating the corresponding reconstructed frame, or both. Although not expressly shown in FIG. 7, decoding using inter-intra prediction with implicit models 700 may include identifying a current frame to decode, reconstruct, or both. The current frame may be a frame, such as the frame 330 shown in FIG. 3, of a video sequence, such as the video sequence 310 shown in FIG. 3. Although described as a frame, the current frame may be a portion of a frame, such as a tile, such as one of the tiles 340 shown in FIG. 3. Decoding using inter-intra prediction with implicit models 700 may include generating a reconstructed frame corresponding to the current frame. Identifying the current frame may include identifying one or more previously decoded, reconstructed, or both, portions, such as blocks, of the reconstructed frame.

A current block may be identified at 710. The current block may be a block of the current frame, such as a block other than a previously decoded or reconstructed block. For example, the current block may be a block, such as block 610 shown in FIG. 6.

Signaled block data may be obtained at 720. For example, obtaining the signaled block data at 720 may include decoding, such as entropy decoding, the signaled block data from the encoded bitstream. Obtaining the signaled block data may include obtaining one or more motion vectors, such as a set of inter-prediction motion vectors, at 720. Obtaining the motion vector, or motion vectors, may include decoding, such as entropy decoding, the motion data, such as inter-prediction motion data, from the encoded bitstream. The motion data may include the motion vector, or motion vectors. Obtaining the motion vector, or motion vectors, may include obtaining reference frame data indicating one or more reference frames, such as a set of reference frames. For example, the motion data may include the reference frame data. The reference frame may indicate, for a respective motion vector, a corresponding reference frame, such as a previously decoded, reconstructed, or both, frame of the video sequence. For example, the motion data may be decoded from a header for the current block.

In some implementations, the set of motion vectors may have a cardinality of one, and the motion information may include one, such as a first, motion vector and one, such as a first, reference frame identifier. In some implementations, the set of motion vectors may have a cardinality of two, and the motion information may include a first motion vector, a first reference frame identifier corresponding to the first motion vector, a second motion vector, and a second reference frame identifier corresponding to the second motion vector. Other cardinalities of motion vectors may be used. Other cardinalities of reference frames may be used. In some implementations, the reference frame, or one or more of the reference frames, may be an alternate reference frame, such as a constructed reference frame, which may be a reference frame other than a displayable reference frame.

Although not shown separately in FIG. 7, decoding using inter-intra prediction with implicit models 700 may include identifying an inter-intra prediction model. For example, obtaining the signaled block data at 720 may include decoding, such as entropy decoding, an inter-intra prediction model identifier indicating the inter-intra prediction model from the encoded bitstream. For example, inter-intra prediction model identifier may be decoded from a header for the current block. In some implementations, the inter-intra prediction model identifier may be an index value to an indexed or ordered set of inter-intra prediction models.

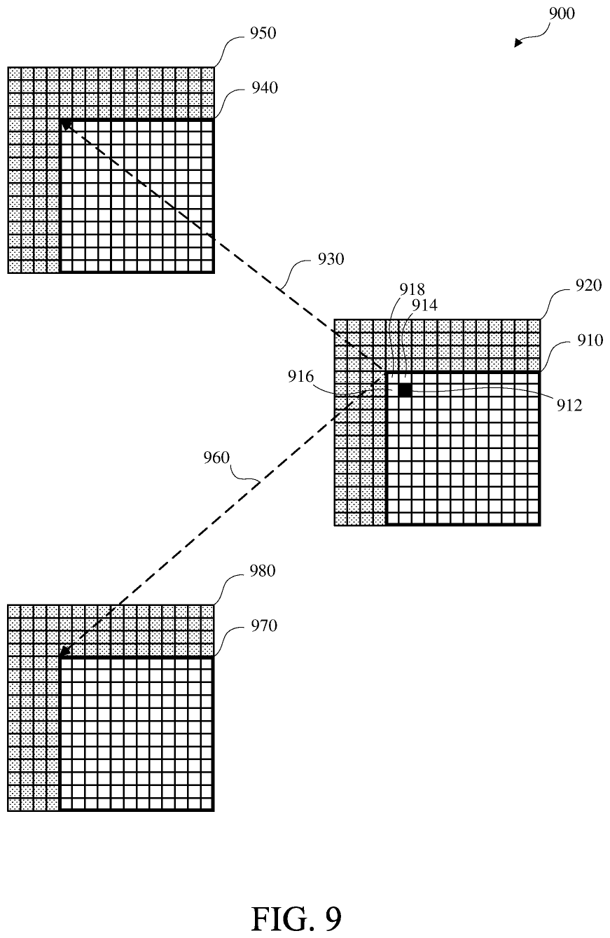

One or more spatial block-context pixels, such as a set of spatial block-context pixels, may be obtained at 730. The spatial block-context pixels may be pixels from the current reconstructed frame, such as previously decoded, reconstructed, or both, pixels from the current reconstructed frame. The spatial block-context pixels may be identified in accordance with a defined spatial orientation relative to the current block. The spatial block-context pixels may correspond with a causal intra-prediction region for intra-prediction of the current block. The defined orientation may indicate that the spatial block-context pixels are oriented proximate to, such as adjacent to or neighboring, the current block in the current frame or tile. For example, the spatial block-context pixels may include pixels from one or more blocks above the current block, one or more blocks to the left of the current block, one or more blocks above and to the left of the current block, or a combination thereof. Other orientations of spatial block-context pixels relative to the current block in the current frame or tile may be used. Identifying the spatial block-context pixels may be similar to identifying context pixels for intra-prediction, except as is described herein or as is otherwise clear from context. In an example, the spatial block-context pixels may be the pixels from the four nearest neighboring rows above the current block, the pixels from the four nearest neighboring columns to the left of the current block, and the pixels from the four nearest neighboring rows and columns above and to the left of the current block. An example of obtaining spatial block-context pixels is shown in FIG. 9. In some implementations, decoding using inter-intra prediction with implicit models 700 may omit obtaining or otherwise accessing intra-prediction pixels for the current block.

In some implementations, information describing the set of spatial block-context pixels may be extracted, such as decoded, or otherwise accessed, from the encoded bitstream, which may include information describing a cardinality of the set of spatial block-context pixels, information indicating the orientation or relative location of the set of spatial block-context pixels, or respective pixels thereof, or both. In some implementations, the inter-intra prediction model identifier may be associated with a defined description of the set of spatial block-context pixels.

One or more inter-prediction blocks, such as a set of inter-prediction blocks, may be generated at 740. The inter-prediction block, or blocks, may be generated using one or more motion vectors, such as the motion vectors identified at 720. The inter-prediction block, or blocks, may be generated using one or more reference frames, such as the reference frames identified at 720. The inter-prediction block, or blocks, may be generated based on samples from the respective reference frame as identified spatially by the respective motion vector, which may include interpolating, or otherwise deriving, pixel values for the inter-prediction block using the pixel values of the reference frame. The block dimensions of the inter-prediction block, or of respective inter-prediction blocks, may correspond with the block dimensions of the current block.

Generating the inter-prediction block, or blocks, may include generating one or more reference block-context pixel sets, such as a set of reference block-context pixel sets, wherein a reference block-context pixel set includes a set of reference block-context pixels oriented relative to the respective inter-prediction block in accordance with the defined spatial orientation, corresponding to the respective inter-prediction block. Generating the reference block-context pixels, which may include generating interpolated, or otherwise derived, reference block-context pixel values, may be similar to generating the inter-prediction block, except that the reference block-context pixels may be oriented relative to the respective inter-prediction block in accordance with the defined spatial orientation. The defined spatial orientation may be the defined spatial orientation used for obtaining the spatial block-context pixels at 730. In an example, the reference block-context pixels may be generated based on the pixels from the reference frame spatially near the portion of the reference frame identified by the corresponding motion vector in accordance with the defined spatial orientation, such as pixels from the four nearest neighboring rows above the portion of the reference frame identified by the corresponding motion vector, the pixels from the four nearest neighboring columns to the left of the portion of the reference frame identified by the corresponding motion vector, and the pixels from the four nearest neighboring rows and columns above and to the left of the portion of the reference frame identified by the corresponding motion vector. The cardinality and spatial pattern of the set of reference block-context pixel corresponding to a respective motion vector and reference frame may be equivalent to the cardinality and spatial pattern of the set of spatial block-context pixels. An example of obtaining reference block-context pixels is shown in FIG. 9.

For example, the current block may be a 32×32 pixel block. The spatial block-context pixels obtained at 730 may be oriented above, to the left, and above and to the left of the current block, and may include 128 pixels from the four nearest rows above the current block in the reconstructed frame, 128 pixels from the four nearest columns to the left of the current block in the reconstructed frame, and 16 pixels from the four nearest rows and columns above and to the left of the current block in the reconstructed frame. The set of motion vectors may have a cardinality of one and may include a first motion vector associated with a first reference frame. A first inter-prediction block may be generated in accordance with the first motion vector and the first reference frame, which may include generating a first inter-prediction block, which may be a 32×32 inter-prediction block, and which may include generating reference block-context pixels, which may include 128 pixels for the four nearest rows above the first inter-prediction block, 128 pixels for the four nearest columns to the left of the first inter-prediction block, and 16 pixels from the four nearest rows and columns above and to the left of the first inter-prediction block.

One or more inter-intra prediction parameters, such as a set of inter-intra prediction parameters, may be obtained at 750. The inter-intra prediction parameter, or parameters, may be obtained using the spatial block-context pixels obtained at 730 and the reference block-context pixels generated at 740. Obtaining the inter-intra prediction parameter, or parameters, may include comparing the spatial block-context pixels with the reference block-context pixels. Obtaining the inter-intra prediction parameter, or parameters, may include generating the inter-intra prediction parameter, or parameters, by solving a least-squares problem using the spatial block-context pixels and the reference block-context pixels. Solving the least-squares problem may probabilistically determine the inter-intra prediction parameter, or parameters, that minimize the error in the spatial block-context pixels as predicted by the reference block-context pixels.

Obtaining the inter-intra prediction parameter, or parameters, may include obtaining one or more blending parameters, such as a set of blending parameters. The cardinality of the set of blending parameters may be the cardinality of the set of motion-vectors, which may be the cardinality of the set of inter-prediction blocks, which may be the cardinality of the set of reference block-context pixel sets. For example, the cardinality of the set of motion-vectors may be one, the cardinality of the set of inter-prediction blocks may be one, the cardinality of the set of reference block-context pixel sets may be one, and the cardinality of the set of blending parameters may be one, which may include a first blending parameter (a). In another example, the cardinality of the set of motion-vectors may be two, the cardinality of the set of inter-prediction blocks may be two, the cardinality of the set of reference block-context pixel sets may be two, and the cardinality of the set of blending parameters may be two, which may include the first blending parameter (a) and a second blending parameter (β). In some implementations, the cardinality of the set of blending parameters may differ from the cardinality of the set of motion-vectors, the cardinality of the set of inter-prediction blocks, and the cardinality of the set of reference block-context pixel sets. For example, the cardinality of the set of motion-vectors may be two, the cardinality of the set of inter-prediction blocks may be two, the cardinality of the set of reference block-context pixel sets may be two, and the cardinality of the set of blending parameters may be one, which may include the first blending parameter (α).

Obtaining the inter-intra prediction parameter, or parameters, may include obtaining an offset (δ).

For example, solving the least-squares problem to obtain the first blending parameter (α) and the offset (δ) may include determining a sum (sx) of the pixel values in the reference block-context pixels, determining a sum (sy) of the pixel values in the spatial block-context pixels, determining a sum (sx2) of the squares of the pixel values in the reference block-context pixels, determining a sum (sxy) of respective products of the pixel values of corresponding reference block-context pixels and spatial block-context pixels, determining a cardinality (n) of pixels in the spatial block-context pixels (or the reference block-context pixels), wherein determining the first blending parameter (α) and the offset (δ) may be expressed as the following:

α=(n*sxy−sx*sy)/(sx2*n−sx*sx),

δ=(−sx*sxy+sx2*sy)/(sx2*n−sx*sx). Equation 1.

In another example, solving the least-squares problem to obtain the first blending parameter (α) and the offset (δ) may include identifying a value of a reference block-context pixel (u) in the reference block-context pixels, identifying a value of a spatial block-context pixel (z) in the spatial block-context pixels, wherein the orientation of the reference block-context pixel (u) with respect to the inter-prediction block is equivalent to the orientation of the spatial block-context pixel (z) with respect to the current block, such that the spatial block-context pixel (z) is approximately, such as within a defined threshold, equal to a sum of adding the offset (δ) to a product of multiplying the first blending parameter (α) by the reference block-context pixel (u), which may be expressed as the following:

z≈α·u+δ. Equation 2.

For simplicity and clarity, a reference block-context pixel (u) in the reference block-context pixels and a spatial block-context pixel (z) in the spatial block-context pixels may be referred to herein as co-oriented to indicate that the orientation (i) of the reference block-context pixel (uᵢ) with respect to the inter-prediction block is equivalent to the orientation of the spatial block-context pixel (z) with respect to the current block. A co-oriented set, or pair, of a reference block-context pixel (uᵢ) and a spatial block-context pixel (zᵢ) may be expressed as {uᵢ, zᵢ}. For the respective pixels of the spatial block-context pixels and the reference block-context pixels, Equation 2 may be expressed in matrix-vector form as the following:

$${\underbrace{( \begin{matrix}{z}_{0} \\ {z}_{1} \\ .\end{matrix} )}}_{\overline{z}} ≅ {\underbrace{( \begin{matrix}{u}_{0} & 1 \\ {u}_{1} & 1 \\ . & .\end{matrix} )}}_{P} ( \begin{matrix}α \\ δ\end{matrix} ) . \qquad Equation 3$$

For a set of spatial block-context pixels, or reference block-context pixels, having a cardinality of (n), (z̅) may indicate an n×1 vector, (P) may indicate a n×2 matrix. For example, such as in the example shown in FIG. 9, the current block may be a w×h block, the spatial block-context pixels may include b pixels per row or column uniformly above, to the left, and above and to the left relative to the current block, as shown in FIG. 9 at 920, the reference block-context pixels may include b pixels per row or column uniformly above, to the left, and above and to the left relative to the inter-prediction block, as shown in FIG. 9 at 950, 980, and the cardinality (n), of the spatial block-context pixels, or the reference block-context pixels, may be expressed as the following:

n=b(w+h+b). Equation 4.

The error minimizing least-squares estimate to obtain the first blending parameter (α) and the offset (δ) may be expressed as the following:

$$( \begin{matrix}α \\ δ\end{matrix} ) = {( {P}^{t} P )}^{- 1} {P}^{t} \overline{z} . \qquad Equation 5$$

In another example, solving the least-squares problem to obtain the first blending parameter (α), the second blending parameter (β), and the offset (δ) may include identifying a value of a first reference block-context pixel (u) in a first set of reference block-context pixels, identifying a value of a second reference block-context pixel (v) in a second set of reference block-context pixels, identifying a value of a spatial block-context pixel (z) in the spatial block-context pixels, wherein the orientation of the first reference block-context pixel (u) with respect to a corresponding first inter-prediction block is equivalent to the orientation of the second reference block-context pixel (v) with respect to a corresponding second inter-prediction block and is equivalent to the orientation of the spatial block-context pixel (z) with respect to the current block, such that the spatial block-context pixel (z) is approximately, such as within a defined threshold, equal to a sum of adding the offset (δ) to a product of multiplying the first blending parameter (α) by the reference block-context pixel (u), which may be expressed as the following:

z≈α·u+β·v+δ. Equation 6.

A co-oriented set, or triplet (which may also be referred to herein as a pair for simplicity), of a first reference block-context pixel (uᵢ), a second reference block-context pixel (vᵢ), and a spatial block-context pixel (zᵢ) may be expressed as {uᵢ, vᵢ, zᵢ}. For the respective pixels of the first spatial block-context pixels, the second spatial block-context pixels, and the reference block-context pixels, Equation 6 may be expressed in matrix-vector form as the following:

$${\underbrace{( \begin{matrix}{z}_{0} \\ {z}_{1} \\ .\end{matrix} )}}_{\overline{z}} ≅ {\underbrace{( \begin{matrix}{u}_{0} & {v}_{0} & 1 \\ {u}_{1} & {v}_{1} & 1 \\ . & . & .\end{matrix} )}}_{P} ( \begin{matrix}α \\ β \\ δ\end{matrix} ) . \qquad Equation 7$$

For a set of spatial block-context pixels, or the respective sets of reference block-context pixels, having a cardinality of (n), (z̅) may indicate an n×1 vector, (P) may indicate a n×3 matrix.

The error minimizing least-squares estimate to obtain the first blending parameter (α), the second blending parameter (β), and the offset (δ) may be expressed as the following:

$$( \begin{matrix}α \\ β \\ δ\end{matrix} ) = {( {P}^{t} P )}^{- 1} {P}^{t} \overline{z} . \qquad Equation 8$$

Other solutions to the least-squares problem, such as solutions using a machine learning model, such as neural network, may be used.

Obtaining the inter-intra prediction parameter, or parameters, may include obtaining one or more recursive factors, such as a set of recursive factors. For example, the set of recursive factors may include three recursive factors (γ₁₀, γ₀₁, γ₁₁).

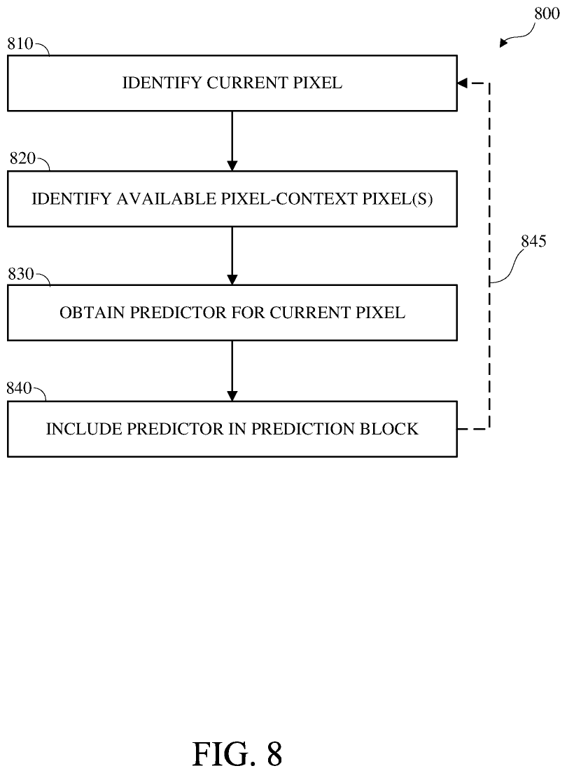

A prediction block may be generated at 760. The prediction block may be generated based on the set of inter-prediction blocks, the set of spatial block-context pixels, the set of inter-intra prediction parameters, or a combination thereof. Generating the prediction block may include generating a respective predictor, or predicted pixel, for a respective pixel, or pixel location, for the current block. An example of generating the prediction block is shown in FIG. 8.

A reconstructed block may be generated at 770. Generating the reconstructed block at 770 may include decoding a residual block from the encoded bitstream. Generating the reconstructed block at 770 may include combining the prediction block and the residual block to obtain the reconstructed block. For example, a value of a current pixel of the reconstructed block may be determined using a sum of the corresponding predictor and the corresponding residual pixel.

The reconstructed block may be output at 780. For example, the reconstructed block may be included in the reconstructed frame, and the reconstructed frame may be output, such as via the output video stream 504 shown in FIG. 5, such as for presentation to a user. Although not shown expressly in FIG. 7, generating the reconstructed block or the reconstructed frame may include filtering, such as the filtering shown at 560 in FIG. 5.

Other implementations of decoding using inter-intra prediction with implicit models 700 are available. For example, other cardinalities of motion vectors or recursive factors may be used.

FIG. 8 is a flowchart diagram of an example of generating a prediction block for coding, such as encoding or decoding, using inter-intra prediction with implicit models 800 in accordance with implementations of this disclosure. Generating a prediction block for coding using inter-intra prediction with implicit models 800 may be implemented in a decoder, such as the decoder 500 shown in FIG. 5, or an encoder, such as the encoder 400 shown in FIG. 4.

As shown in FIG. 8, generating a prediction block for coding using inter-intra prediction with implicit models 800 includes identifying a current pixel of a current block at 810, identifying one or more inter-prediction pixels corresponding to the current pixel at 820, obtaining a predictor for the current pixel at 830, and including the predictor in the prediction block at 840.

A current pixel of a current block may be identified at 810. The current block may be a current block for reconstruction, such as the current block identified as shown at 710 in FIG. 7. The current pixel may be a pixel other than a previously reconstructed pixel from the current block. For example, the current pixel may be a pixel from the current block along one or more edges or boarders of the current block, such as the top-left pixel of the current block. In another example, the current pixel may be adjacent to one or more previously reconstructed pixels from the current block, such as a previously reconstructed pixel from the current block adjacent, in a defined direction, such as to the left of or above, the current pixel. Identifying the current pixel may include identifying a pixel location corresponding to the current pixel.

One or more inter-prediction pixels, such as a set of inter-prediction pixels, corresponding to the current pixel may be identified at 820. For example, the set of inter-prediction blocks, generated as shown at 740 in FIG. 7, may have a cardinality of one and may include a first inter-prediction block, and one inter-prediction pixel spatially, within the respective blocks, corresponding to the current pixel may be identified. In another example, the set of inter-prediction blocks, generated as shown at 740 in FIG. 7, may have a cardinality of two, may include a first inter-prediction block and a second inter-prediction block, a first inter-prediction pixel spatially, within the respective blocks, corresponding to the current pixel may be identified from the first inter-prediction block and a second inter-prediction pixel spatially, within the respective blocks, corresponding to the current pixel may be identified from the second inter-prediction block.

A predictor for the current pixel may be obtained at 830.

In some implementations, a first inter-intra prediction model may include using one motion vector and one blending parameter. The first inter-intra prediction model may omit using other motion vectors, determining other blending parameters, determining an offset, and determining recursive factors. In accordance with the first inter-intra prediction model the predictor (P[i, j]) for the current pixel, which may be the pixel from the current block in the ith row and the jth column, may be obtained as a product of the inter-prediction pixel (Pᵢₙₜₑᵣ₁[i,j]) and the blending parameter (α), which may be expressed as the following:

P[i,j]=α·P_{Inter1}[i,j]

In some implementations, a second inter-intra prediction model may include using one motion vector, one blending parameter (α), and an offset (δ). The second inter-intra prediction model may omit using other motion vectors, determining other blending parameters, and determining recursive factors. In accordance with the second inter-intra prediction model the predictor (P[i, j]) for the current pixel, which may be the pixel from the current block in the ith row and the jth column, may be obtained as a sum of the offset (δ) and a product of the inter-prediction pixel (Pᵢₙₜₑᵣ₁[i,j]) and the blending parameter (α), which may be expressed as the following:

P[i,j]=α·P_{Inter1}[i,j]+δ.

In some implementations, a third inter-intra prediction model may include using two motion vectors and one blending parameter. The third inter-intra prediction model may omit using other motion vectors, determining other blending parameters, determining an offset, and determining recursive factors. In accordance with the third inter-intra prediction model the predictor (P[i, j]) for the current pixel, which may be the pixel from the current block in the ith row and the jth column, may be obtained as a sum of a product of a first inter-prediction pixel (Pᵢₙₜₑᵣ₁[i,j]) from a first inter-prediction block corresponding to the first motion vector and the blending parameter (α) and a product of a second inter-prediction pixel (Pᵢₙₜₑᵣ₂[i,j])]) from a second inter-prediction block corresponding to the second motion vector and the difference between one and the blending parameter (α), which may be expressed as the following:

P[i,j]]=α·P_{Inter1}[i,j]+1−α·P_{Inter2}[i,j].

In some implementations, a fourth inter-intra prediction model may include using two motion vectors, one blending parameter (α), and an offset (δ). The fourth inter-intra prediction model may omit using other motion vectors, determining other blending parameters, and determining recursive factors. In accordance with the fourth inter-intra prediction model the predictor (P[i, j]) for the current pixel, which may be the pixel from the current block in the ith row and the jth column, may be obtained as a sum of the offset (δ), a product of a first inter-prediction pixel (Pᵢₙₜₑᵣ₁[i,j] from a first inter-prediction block corresponding to the first motion vector and the blending parameter (α), and a product of a second inter-prediction pixel (Pᵢₙₜₑᵣ₂[i,j])]) from a second inter-prediction block corresponding to the second motion vector and the difference between one and the blending parameter (α), which may be expressed as the following:

P[i,j]]=α·P_{Inter1}[i,j]+1−α·P_{Inter2}[i,j]+δ.

In some implementations, a fifth inter-intra prediction model may include using two motion vectors and two blending parameters (α, β). The fifth inter-intra prediction model may omit using other motion vectors, determining other blending parameters, determining an offset, and determining recursive factors. In accordance with the fifth inter-intra prediction model the predictor (P[i, j]) for the current pixel, which may be the pixel from the current block in the ith row and the jth column, may be obtained as a sum of a product of a first inter-prediction pixel (Pᵢₙₜₑᵣ₁[i,j]) from a first inter-prediction block corresponding to the first motion vector and the first blending parameter (α) and a product of a second inter-prediction pixel (Pᵢₙₜₑᵣ₂[i,j])]) from a second inter-prediction block corresponding to the second motion vector and the second blending parameter (β), which may be expressed as the following:

P[i,j]]=α·P_{Inter1}[i,j]+β·P_{Inter2}[i,j].

In some implementations, a sixth inter-intra prediction model may include using two motion vectors, two blending parameters (α, β), and the offset (δ). The sixth inter-intra prediction model may omit using other motion vectors, determining other blending parameters, and determining recursive factors. In accordance with the sixth inter-intra prediction model the predictor (P[i, j]) for the current pixel, which may be the pixel from the current block in the ith row and the jth column, may be obtained as a sum of the offset (δ), a product of a first inter-prediction pixel (Pᵢₙₜₑᵣ₁[i,j]) from a first inter-prediction block corresponding to the first motion vector and the blending parameter (α), and a product of a second inter-prediction pixel (Pᵢₙₜₑᵣ₂[i,j])]) from a second inter-prediction block corresponding to the second motion vector and the second blending parameter (β) which may be expressed as the following:

P[i,j]]=α·P_{Inter1}[i,j]+β·P_{Inter2}[i,j]+δ.

In some implementations, a seventh inter-intra prediction model, which may be an example of adaptive filter inter-intra prediction, may include using one motion vector, one blending parameter, and one or more recursive factors, such as a set of recursive factors. The seventh inter-intra prediction model may omit using other motion vectors, determining other blending parameters, and determining an offset. In accordance with the seventh inter-intra prediction model obtaining the predictor (P[i, j]) for the current pixel, which may be the pixel from the current block in the ith row and the jth column, may include obtaining a first product of the inter-prediction pixel (Pᵢₙₜₑᵣ₁[i,j]). In accordance with the seventh inter-intra prediction model, obtaining the predictor (P[i, j]) for the current pixel may include obtaining a second product of a first recursive factor (γ₁₀) and a first previously regenerated available pixel-context pixel from the current frame, such as from the current block, in accordance with a defined orientation relative to the current pixel. For example, the first available pixel-context pixel may be a previously regenerated pixel from the current frame immediately above the current pixel, which may be a previously regenerated pixel from the current block (P[i−1, j]). In accordance with the seventh inter-intra prediction model, obtaining the predictor (P[i, j]) for the current pixel may include obtaining a third product of a second recursive factor (γ₀₁) and a second previously regenerated available pixel-context pixel from the current frame, such as from the current block, in accordance with a defined orientation relative to the current pixel. For example, the second available pixel-context pixel may be a previously regenerated pixel from the current frame immediately to the left of the current pixel, which may be a previously regenerated pixel from the current block (P[i, j−1]). In accordance with the seventh inter-intra prediction model, obtaining the predictor (P[i, j]) for the current pixel may include obtaining a fourth product of a third recursive factor (γ₁₁) and a third previously regenerated available pixel-context pixel from the current frame, such as from the current block, in accordance with a defined orientation relative to the current pixel. For example, the second available pixel-context pixel may be a previously regenerated pixel from the current frame immediately to the left of the current pixel, which may be a previously regenerated pixel from the current block (P[i−1, j−1]). In accordance with the seventh inter-intra prediction model, obtaining the predictor (P[i, j]) for the current pixel may include obtaining, as the predictor, a sum of the first product, the second product, the third product, and the fourth product. In accordance with the seventh inter-intra prediction model, obtaining the predictor (P[i, j]) for the current pixel may be expressed as the following:

P[i,j]=α·P_{Inter1}[i,j]+γ₁₀·P[i−1,j]+γ₀₁·P[i,j−1]+γ₁₁·P[i−1,j−1].

Although the example described herein includes a set of recursive factors having a cardinality of three and a set of previously regenerated available pixel-context pixels having a cardinality of three, other cardinalities of recursive factors and previously regenerated available pixel-context pixels may be used.

In some implementations, an eighth inter-intra prediction model may be similar to the seventh inter-intra prediction model except that the offset (δ) may be used, which may be expressed as the following:

P[i,j]=α·P_{Inter1}[i,j]+γ₁₀·P[i−1,j]+γ₀₁·P[i,j−1]+γ₁₁·P[i−1,j−1]+δ.

In some implementations, a ninth inter-intra prediction model may be similar to the seventh inter-intra prediction model except that two motion vectors and two corresponding inter-prediction blocks (P_{Inter1}, P_{Inter2}) may be used, which may be expressed as the following:

P[i,j]=α·P_{Inter1}[i,j]+1−α·P_{Inter2}[i,j]+γ₁₀·P[i−1,j]+γ₀₁·P[i,j−1]+γ₁₁·P[i−1,j−1].

In some implementations, a tenth inter-intra prediction model may be similar to the ninth inter-intra prediction model except that the offset (δ) may be used, which may be expressed as the following:

P[i,j]=α·P_{Inter1}[i,j]+1−α·P_{Inter2}[i,j]+γ₁₀·P[i−1,j]+γ₀₁·P[i,j−1]+γ₁₁·P[i−1,j−1]+δ.

In some implementations, an eleventh inter-intra prediction model may be similar to the ninth inter-intra prediction model except that two blending parameters (α, β) may be used, which may be expressed as the following:

P[i,j]=α·P_{Inter1}[i,j]+β·P_{Inter2}[i,j]+γ₁₀·P[i−1,j]+γ₀₁·P[i,j−1]+γ₁₁·P[i−1,j−1].

In some implementations, a twelfth inter-intra prediction model may be similar to the eleventh inter-intra prediction model except that the offset (δ) may be used, which may be expressed as the following:

P[i,j]=α·P_{Inter1}[i,j]+β·P_{Inter2}[i,j]+γ₁₀·P[i−1,j]+γ₀₁·P[i,j−1]+γ₁₁·P[i−1,j−1]+δ.

The predictor may be included in the prediction block at 840. Obtaining the prediction block may include obtaining a respective predictor for the pixels of the current block as indicated by the broken directional line at 845.

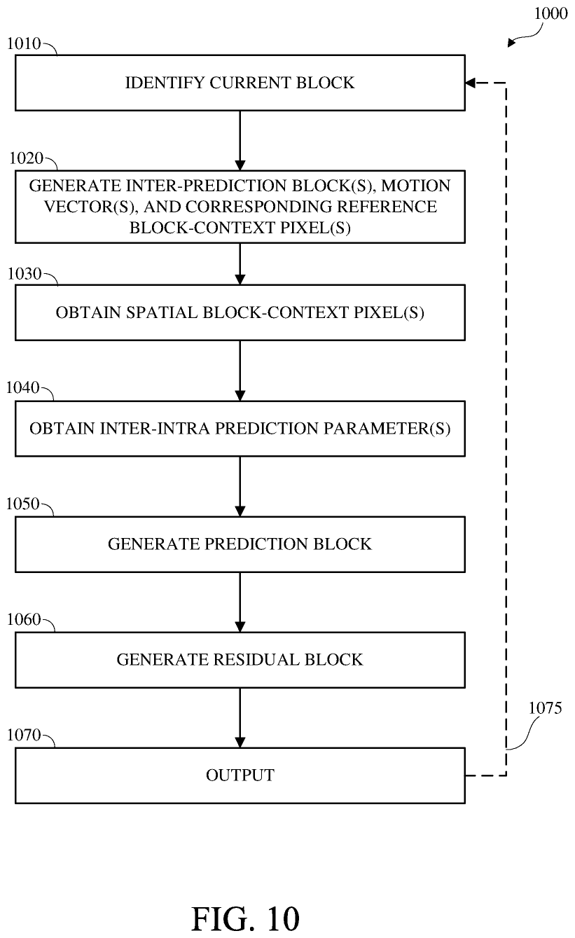

FIG. 9 is a block diagram of an example of image elements for coding using inter-intra prediction with implicit models 900 in accordance with implementations of this disclosure, such as the decoding using inter-intra prediction with implicit models 700 or the encoding using inter-intra prediction with implicit models 1000 shown in FIG. 10.

FIG. 9 shows a current block 910 (P[ ]) of a current frame. The current block 910 includes a current pixel 912, a first pixel-context pixel 914 immediately above the current pixel 912, a second pixel-context pixel 916 immediately to the left of the current pixel 912, and a third pixel-context pixel 918 immediately above and to the left of the current pixel 912. The pixel-context pixels 914, 916, 918 are oriented with respect to the current pixel 912 in accordance with a first defined orientation, such as a defined pixel-context orientation. Other cardinalities and orientations of the pixel-context pixels may be used. The pixels of a block, such as the current block 910, may be referenced using Cartesian coordinates relative to the current pixel. For example, the current pixel 912 may be expressed as p[i,j], which may be p[1,1] as shown. The first pixel-context pixel 914 may be expressed as p[i−1, j], which may be P[0,1] as shown. The second pixel-context pixel 916 may be expressed as p[i, j−1], which may be P[1,0] as shown. The third pixel-context pixel 918 may be expressed as p[i−1, j−1], which may be P[0,0] as shown. In some implementations (not expressly shown), the current pixel may be adjacent to a boarder of the current block, such as the top-left pixel of the current block, and one or more of the pixel-context pixels may be obtained from outside the current block, such as from a block adjacent to the current block in the current frame.

FIG. 9 shows spatial block-context pixels 920. As shown in FIG. 9, the spatial block-context pixels include pixels from four rows of the current frame immediately above the current block, pixels from four columns of the current frame immediately to the left of the current block, and pixels from four columns of the current frame and four rows of the current frame immediately above and to the left of the current block. The spatial block-context pixels 920 may be previously reconstructed pixels from blocks from the current frame other than the current block. The spatial block-context pixels 920 are oriented with respect to the current block 910 in accordance with a second defined orientation, such as a defined block-context orientation. Other cardinalities and orientations of the spatial block-context pixels 920 may be used. The spatial block-context pixels 920 may be referenced using Cartesian coordinates relative to the current block, such as relative to the top-left pixel of the current block. For example, the spatial block-context pixel at the top-left of the spatial block-context pixels 920 may be expressed as P[i−4, j−4].

FIG. 9 shows a first motion vector 930. FIG. 9 shows a first inter-prediction block 940 which may be obtained from, such as interpolated or otherwise derived, a portion of a first reference frame (not separately shown) indicated by the first motion vector 930. FIG. 9 shows first reference block-context pixels 950 above, to the left of, and above and to the left of the first inter-prediction block 940. The first reference block-context pixels 950 may be obtained similar to the first inter-prediction block 940, such as interpolated or otherwise derived from a portion of the first reference frame indicated by the first motion vector, except that the first reference block-context pixels 950 are oriented with respect to the first inter-prediction block 940 in accordance with the second defined orientation. The first reference block-context pixels 950 may be referenced using Cartesian coordinates relative to the current block, such as relative to the top-left pixel of the current block. For example, the reference block-context pixel at the top-left of the first reference block-context pixels 950 may be expressed as P_{Inter1}[i−4, j−4].

FIG. 9 shows a second motion vector 960. FIG. 9 shows a second inter-prediction block 970 which may be obtained from, such as interpolated or otherwise derived, a portion of a second reference frame (not separately shown) indicated by the second motion vector 960. FIG. 9 shows second reference block-context pixels 980 above, to the left of, and above and to the left of the second inter-prediction block 970. The second reference block-context pixels 980 may be obtained similar to the second inter-prediction block 970, such as interpolated or otherwise derived from a portion of the second reference frame indicated by the second motion vector, except that the second reference block-context pixels 980 are oriented with respect to the second inter-prediction block 970 in accordance with the second defined orientation. The second reference block-context pixels 980 may be referenced using Cartesian coordinates relative to the current block, such as relative to the top-left pixel of the current block. For example, the reference block-context pixel at the top-left of the second reference block-context pixels 980 may be expressed as P_{Inter2}[i−4, j−4].

FIG. 10 is a flowchart diagram of an example of encoding using inter-intra prediction with implicit models 1000 in accordance with implementations of this disclosure. Encoding using inter-intra prediction with implicit models 1000 may be implemented in an encoder, such as the encoder 400 shown in FIG. 4. Encoding using inter-intra prediction with implicit models 1000 may be similar to decoding using inter-intra prediction with implicit models 700, except as is described herein or as is otherwise clear from context.

As shown in FIG. 10, encoding using inter-intra prediction with implicit models 1000 includes identifying a current block at 1010, generating inter-prediction data at 1020, obtaining one or more spatial block-context pixels at 1030, obtaining one or more inter-intra prediction parameters at 1040, generating a prediction block at 1050, generating a residual block at 1060, and outputting at 1070.

Although not expressly shown in FIG. 10, encoding using inter-intra prediction with implicit models 1000 may include obtaining at least a portion of an input video stream. Although not expressly shown in FIG. 10, encoding using inter-intra prediction with implicit models 1000 may include identifying a current frame to encode, such as an input frame of the input video stream. The current frame may be a frame, such as the frame 330 shown in FIG. 3, of a video sequence, such as the video sequence 310 shown in FIG. 3. Although described as a frame, the current frame may be a portion of a frame, such as a tile, such as one of the tiles 340 shown in FIG. 3. Although not expressly shown in FIG. 10, encoding using inter-intra prediction with implicit models 1000 may include generating a portion of reconstructed frame for the current frame based on previously encoded portions of the current frame. Identifying the current frame may include identifying one or more previously encoded, reconstructed, or both, portions, such as blocks, of the reconstructed frame.

Although not shown separately in FIG. 10, encoding using inter-intra prediction with implicit models 1000 may include identifying an inter-intra prediction model, which may include identifying an inter-intra prediction model identifier indicating, or identifying, the inter-intra prediction model. In some implementations, the inter-intra prediction model may be identified using rate-distortion optimization.

A current block may be identified at 1010. The current block may be a block of the current frame, such as a block other than a previously encoded block. For example, the current block may be a block, such as block 610 shown in FIG. 6.

Inter-prediction data for the current block may be generated at 1020. Generating the inter-prediction data may include generating one or more motion vectors, such as a set of inter-prediction motion vectors, for inter-prediction of the current block. A respective motion vector may be associated with a corresponding reference frame. The reference frame may indicate, for a respective motion vector, a corresponding reference frame, such as a previously encoded, reconstructed, or both, frame from the video sequence.

One or more inter-prediction blocks, such as a set of inter-prediction blocks, may be generated at 1020. The inter-prediction block, or blocks, may be generated using one or more motion vectors, such as the motion vectors identified at 1020. The inter-prediction block, or blocks, may be generated using one or more reference frames, such as the reference frames identified at 1020. A motion vector may be associated with a corresponding reference frame. The inter-prediction block, or blocks, may be generated based on samples from the respective reference frame as identified spatially by the respective motion vector, which may include interpolating, or otherwise deriving, pixel values for the inter-prediction block using the pixel values of the reference frame. The block dimensions of the inter-prediction block, or of respective inter-prediction blocks, may correspond with the block dimensions of the current block.

Generating the inter-prediction block, or blocks, may include generating one or more reference block-context pixel sets, such as a set of reference block-context pixel sets, wherein a reference block-context pixel set includes a set of reference block-context pixels oriented relative to the respective inter-prediction block in accordance with the defined spatial orientation, corresponding to the respective inter-prediction block. Generating the reference block-context pixels, which may include generating interpolated, or otherwise derived, reference block-context pixel values, may be similar to generating the inter-prediction block, except that the reference block-context pixels may be oriented relative to the respective inter-prediction block in accordance with the defined spatial orientation. The defined spatial orientation may be the defined spatial orientation used for obtaining the spatial block-context pixels at 1030. In an example, the reference block-context pixels may be generated based on the pixels from the reference frame spatially near the portion of the reference frame identified by the corresponding motion vector in accordance with the defined spatial orientation, such as pixels from the four nearest neighboring rows above the portion of the reference frame identified by the corresponding motion vector, the pixels from the four nearest neighboring columns to the left of the portion of the reference frame identified by the corresponding motion vector, and the pixels from the four nearest neighboring rows and columns above and to the left of the portion of the reference frame identified by the corresponding motion vector. The cardinality and spatial pattern of the set of reference block-context pixel corresponding to a respective motion vector and reference frame may be equivalent to the cardinality and spatial pattern of the set of spatial block-context pixels. An example of obtaining reference block-context pixels is shown in FIG. 9.

One or more spatial block-context pixels, such as a set of spatial block-context pixels, may be obtained at 1030. The spatial block-context pixels may be pixels from the current reconstructed frame, such as previously encoded, reconstructed, or both, pixels from the current reconstructed frame. The spatial block-context pixels may be identified in accordance with a defined spatial orientation relative to the current block. The spatial block-context pixels may correspond with a causal intra-prediction region for intra-prediction of the current block. The defined orientation may indicate that the spatial block-context pixels are oriented proximate, such as adjacent, to the current block. For example, the spatial block-context pixels may include pixels from one or more blocks above the current block, one or more blocks to the left of the current block, one or more blocks above and to the left of the current block, or a combination thereof. Other orientations of spatial block-context pixels relative to the current block may be used. Identifying the spatial block-context pixels may be similar to identifying context pixels for intra-prediction, except as is described herein or as is otherwise clear from context. In an example, the spatial block-context pixels may be the pixels from the four nearest neighboring rows above the current block, the pixels from the four nearest neighboring columns to the left of the current block, and the pixels from the four nearest neighboring rows and columns above and to the left of the current block. An example of obtaining spatial block-context pixels is shown in FIG. 9. In some implementations, encoding using inter-intra prediction with implicit models 1000 may omit obtaining or otherwise accessing intra-prediction pixels for the current block.

One or more inter-intra prediction parameters, such as a set of inter-intra prediction parameters, may be obtained at 1040. The inter-intra prediction parameter, or parameters, may be obtained using the spatial block-context pixels obtained at 1030 and the reference block-context pixels generated at 1020. Obtaining the inter-intra prediction parameter, or parameters, may include comparing the spatial block-context pixels with the reference block-context pixels. Obtaining the inter-intra prediction parameter, or parameters, may include generating the inter-intra prediction parameter, or parameters, by solving a least-squares problem using the spatial block-context pixels and the reference block-context pixels. Solving the least-squares problem may probabilistically determine inter-intra prediction parameter, or parameters, that minimize the error in the spatial block-context pixels as predicted from the reference block-context pixels.

Obtaining the inter-intra prediction parameter, or parameters, may include obtaining one or more blending parameters, such as a set of blending parameters. The cardinality of the set of blending parameters may be the cardinality of the set of motion-vectors, which may be the cardinality of the set of inter-prediction blocks, which may be the cardinality of the set of reference block-context pixel sets. For example, the cardinality of the set of motion-vectors may be one, the cardinality of the set of inter-prediction blocks may be one, the cardinality of the set of reference block-context pixel sets may be one, and the cardinality of the set of blending parameters may be one, which may include a first blending parameter (α). In another example, the cardinality of the set of motion-vectors may be two, the cardinality of the set of inter-prediction blocks may be two, the cardinality of the set of reference block-context pixel sets may be two, and the cardinality of the set of blending parameters may be two, which may include the first blending parameter (α) and a second blending parameter (β). In some implementations, the cardinality of the set of blending parameters may differ from the cardinality of the set of motion-vectors, the cardinality of the set of inter-prediction blocks, and the cardinality of the set of reference block-context pixel sets. For example, the cardinality of the set of motion-vectors may be two, the cardinality of the set of inter-prediction blocks may be two, the cardinality of the set of reference block-context pixel sets may be two, and the cardinality of the set of blending parameters may be one, which may include the first blending parameter (α).

Obtaining the inter-intra prediction parameter, or parameters, may include obtaining an offset (δ).

Obtaining the inter-intra prediction parameter, or parameters, may include obtaining one or more recursive factors, such as a set of recursive factors. For example, the set of recursive factors may include three recursive factors (γ₁₀, γ₀₁, γ₁₁).

A prediction block may be generated at 1050. The prediction block may be generated based on the set of inter-prediction blocks, the set of spatial block-context pixels, the set of inter-intra prediction parameters, or a combination thereof. Generating the prediction block may include generating a respective predictor, or predicted pixel, for a respective pixel, or pixel location, for the current block. An example of generating the prediction block is shown in FIG. 8.

A residual block may be generated at 1060. Generating the residual block at 1060 may include subtracting the prediction block from the current block to obtain the residual block. For example, a value of a current pixel of the residual block may be determined using a difference of subtracting the corresponding predictor from the corresponding input pixel.

The encoded bitstream may be output at 1070. For example, the residual block may be included in the encoded bitstream and output at 1070, which may include entropy coding the residual block. The motion vector, or motion vectors, may be included in the encoded bitstream and output at 1070 which may include entropy coding the motion vector, or motion vectors. Information indicating the reference frame associated with a respective motion vector may be included in the encoded bitstream and output at 1070 which may include entropy coding the reference frame information. The inter-intra prediction model identifier may be included in the encoded bitstream and output at 1070, which may include entropy coding the inter-intra prediction model identifier.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted from implementations of methods in accordance with the disclosed subject matter.

The implementations of the transmitting computing and communication device 100A and/or the receiving computing and communication device 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. In this instance, the transmitting computing and communication device 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting computing and communication device 100A. Other suitable transmitting computing and communication device 100A and receiving computing and communication device 100B implementation schemes are available. For example, the receiving computing and communication device 100B can be a generally stationary personal computer rather than a portable communications device and/or a device including an encoder 400 may also include a decoder 500.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application are not limiting. On the contrary, the application covers various modifications and equivalent arrangements included within the scope of the appended claims, which scope is to be accorded the broadest interpretation so as to encompass all such modifications and equivalent structure as is permitted under the law.

1.-16. (canceled)

17. An apparatus, comprising:
a processor configured to:
generate a reconstructed frame corresponding to a current frame from a sequence of video frames, wherein to generate the reconstructed frame includes to generate the reconstructed frame in accordance with an inter-intra prediction model, and wherein to generate the reconstructed frame in accordance with the inter-intra prediction model includes to:
decode, from an encoded bitstream, a set of inter-prediction motion vectors for a current block of the current frame;
obtain spatial block-context pixels from the reconstructed frame oriented relative to the current block in accordance with a defined spatial orientation;
generate a set of inter-prediction blocks for the current block using a set of reference frames and the set of inter-prediction motion vectors, wherein to generate the set of inter-prediction blocks includes, for a respective inter-prediction block from the set of inter-prediction blocks, to generate a corresponding set of reference block-context pixels oriented relative to the respective inter-prediction block in accordance with the defined spatial orientation;
identify a set of inter-intra prediction parameters that correspond with minimizing error between the spatial block-context pixels and the reference block-context pixels, wherein the set of inter-intra prediction parameters includes a set of blending parameters, and wherein the set of blending parameters includes a first blending parameter;
generate a prediction block for the current block including to, for a current pixel of the current block:
obtain a set of inter-prediction pixels by, for a respective inter-prediction block from the set of inter-prediction blocks, identifying, from the inter-prediction block, an inter-prediction pixel corresponding to the current pixel, such that the set of inter-prediction pixels includes a first inter-prediction pixel from a first inter-prediction block from the set of inter-prediction blocks;
determine a predictor for the current pixel using a combination of the set of inter-prediction pixels and the set of inter-intra prediction parameters; and
include the predictor in the prediction block;
decode a residual block for the current block from the encoded bitstream, wherein to decode the residual block includes to decode a residual pixel corresponding to the current pixel;
generate a reconstructed block for the current block including to identify, as a current pixel, a sum of the predictor for the current pixel and the residual pixel; and
include the reconstructed block in the reconstructed frame; and
output the reconstructed frame.

18. The apparatus of claim 17, wherein to identify the inter-intra prediction model includes to decode, from the encoded bitstream, an inter-intra prediction model identifier that identifies the inter-intra prediction model.

19. The apparatus of claim 17, wherein:
to decode the set of inter-prediction motion vectors includes to decode a first inter-prediction motion vector of the set of inter-prediction motion vectors, wherein the first inter-prediction motion vector is associated with a first reference frame of the set of reference frames;
to generate the set of inter-prediction blocks includes to generate the first inter-prediction block using the first inter-prediction motion vector and the first reference frame, wherein to generate the first inter-prediction block includes to generate a first set of reference block-context pixels oriented relative to the first inter-prediction block; and
to determine the predictor includes to:
identify a first value as a product of multiplying the first inter-prediction pixel by the first blending parameter; and
identify, as the predictor, a sum of a set of values, wherein the set of values includes the first value.

20. The apparatus of claim 19, wherein:
to identify the set of inter-intra prediction parameters such that the set of inter-intra prediction parameters correspond with minimizing error between the spatial block-context pixels and the first set of reference block-context pixels.

21. The apparatus of claim 19, wherein:
to decode the set of inter-prediction motion vectors includes to decode a second inter-prediction motion vector of the set of inter-prediction motion vectors, wherein the set of reference frames includes a second reference frame;
to generate the set of inter-prediction blocks includes to generate a second inter-prediction block of the set of inter-prediction blocks using the second inter-prediction motion vector and the second reference frame, wherein to generate the second inter-prediction block includes to generate a second set of reference block-context pixels oriented relative to the second inter-prediction block;
to obtain the set of inter-prediction pixels includes to identify, from the second inter-prediction block, a second inter-prediction pixel corresponding to the current pixel, such that the set of inter-prediction pixels includes the second inter-prediction pixel; and
to identify the set of inter-intra prediction parameters includes to identify the set of inter-intra prediction parameters such that the set of inter-intra prediction parameters correspond with minimizing error between the spatial block-context pixels, the first set of reference block-context pixels, and the second set of reference block-context pixels.

22. The apparatus of claim 21, wherein to determine the predictor includes to:
identify a second value as a product of multiplying the second inter-prediction pixel by a difference of subtracting the first blending parameter from one; and
include the second value in the set of values.

23. The apparatus of claim 21, wherein:
to identify the set of inter-intra prediction parameters includes to identify the set of blending parameters such that the set of blending parameters includes a second blending parameter; and
to determine the predictor includes to:
identify a second value as a product of multiplying the second inter-prediction pixel by the second blending parameter; and
include the second value in the set of values.

24. The apparatus of claim 19, wherein:
to identify the set of inter-intra prediction parameters includes to identify a set of recursive factors; and
to determine the predictor includes to:
identify a set of available pixel-context pixels from the reconstructed frame having a defined spatial orientation relative to the current pixel;
identify a dot product of the set of available pixel-context pixels and the set of recursive factors; and
include the dot product in the set of values.

25. The apparatus of claim 19, wherein:
to decode the set of inter-prediction motion vectors includes to decode a second inter-prediction motion vector of the set of inter-prediction motion vectors, wherein the set of reference frames includes a second reference frame;
to generate the set of inter-prediction blocks includes to generate a second inter-prediction block of the set of inter-prediction blocks using the second inter-prediction motion vector and the second reference frame, wherein to generate the second inter-prediction block includes to generate a second set of reference block-context pixels oriented relative to the second inter-prediction block;
to obtain the set of inter-prediction pixels includes to identify, from the second inter-prediction block, a second inter-prediction pixel corresponding to the current pixel, such that the set of inter-prediction pixels includes the second inter-prediction pixel; and
to identify the set of inter-intra prediction parameters includes to identify the set of inter-intra prediction parameters such that the set of inter-intra prediction parameters correspond with minimizing error between the spatial block-context pixels, the first set of reference block-context pixels, and the second set of reference block-context pixels.

26. The apparatus of claim 25, wherein to determine the predictor includes to:
identify a second value as a product of multiplying the second inter-prediction pixel by a difference of subtracting the first blending parameter from one; and
include the second value in the set of values.

27. The apparatus of claim 25, wherein:
to identify the set of inter-intra prediction parameters includes to identify the set of blending parameters such that the set of blending parameters includes a second blending parameter; and
to determine the predictor includes to:
identify a second value as a product of multiplying the second inter-prediction pixel by the second blending parameter; and
include the second value in the set of values.

28. The apparatus of claim 19, wherein:
to identify the set of inter-intra prediction parameters includes identifying an offset; and
to determine the predictor comprises to include the offset in the set of values.

29. A method, comprising:
generating a reconstructed frame corresponding to a current frame from a sequence of frames, wherein generating the reconstructed frame includes:
decoding, from an encoded bitstream, an inter-prediction motion vector for a current block of the current frame;
obtaining spatial block-context pixels from the reconstructed frame oriented relative to the current block in accordance with a defined spatial orientation;
generating an inter-prediction block for the current block using a reference frame and the inter-prediction motion vector, wherein generating the inter-prediction block includes generating reference block-context pixels oriented relative to the inter-prediction block in accordance with the defined spatial orientation;
obtaining an inter-intra prediction parameter that corresponds with minimizing error between the spatial block-context pixels and the reference block-context pixels;
generating a prediction block for the current block by, for a current pixel of the current block:
determining a predictor for the current pixel using a combination of an inter-prediction pixel from the inter-prediction block corresponding to the current pixel and the inter-intra prediction parameter; and
including the predictor in the prediction block;
decoding a residual block for the current block from the encoded bitstream, wherein decoding the residual block includes decoding a residual pixel corresponding to the current pixel;
generating a reconstructed block for the current block by, for the current pixel, identifying a sum of the predictor for the current pixel and the residual pixel as the current pixel; and
including the reconstructed block in the reconstructed frame; and
outputting the reconstructed frame.

30. An apparatus comprising a processor configured to perform the method of claim 29.

31. An apparatus, comprising:
a processor configured to:
generate an encoded frame including to encode a current frame from a sequence of input video frames, wherein to encode the current frame includes to:
generate a portion of a reconstructed frame corresponding to the current frame;
identify a current block of the current frame;
generate a first inter-prediction block for the current block using a first reference frame, wherein to generate the first inter-prediction block includes to:
identify a first inter-prediction motion vector; and
generate first reference block-context pixels oriented relative to the first inter-prediction block in accordance with a defined spatial orientation;
obtain spatial block-context pixels from the reconstructed frame oriented relative to the current block in accordance with the defined spatial orientation;
obtain a first inter-intra prediction parameter that corresponds with minimizing error between the spatial block-context pixels and the first reference block-context pixels;
generate a prediction block for the current block including to, for a current pixel of the current block:
determine a predictor for the current pixel using a combination of an inter-prediction pixel from the first inter-prediction block corresponding to the current pixel and the first inter-intra prediction parameter; and
include the predictor in the prediction block;
generate a residual block for the current block, wherein to generate the residual block includes to generate, as a residual pixel corresponding to the current pixel, a difference between the predictor and the current pixel;
include, in an encoded bitstream, the residual block and the first inter-prediction motion vector; and
output the encoded bitstream.

32. The apparatus of claim 31, wherein to encode the current frame includes to:
identify an inter-intra prediction model; and
include an inter-intra prediction model identifier that identifies the inter-intra prediction model in the encoded bitstream.
